(19) United States
(12) Patent Application Publication
(10) Pub. No.: US 2026/0145747 A1
(43) Pub. Date: May 28, 2026

(54) HOOD STRIKER BRACKET

(71) Applicant: FCA US LLC, Auburn Hills, MI (US)

(72) Inventors: Srinivasa Ragavan Sankaiah, Chennai (IN); Daniele Ghislieri, Torino (IT); Claudio Tarantino, Torino (IT); Modesto Paragano, Torino (IT)

(21) Appl. No.: 18/958,466

(22) Filed: Nov. 25, 2024

(51) Int. Cl. B62D 25/12

(52) U.S. Cl. CPC B62D 25/12

(57) ABSTRACT

A hood striker bracket has a body with a securement member to secure the bracket with a vehicle hood. At least one leg extends from the body. The at least one leg is flexible to absorb energy exerted onto the hood. A flange extends from the leg. The flange extends in a direction towards the body with a vertex formed in the at least one leg.

### FIELD

The present disclosure relates to vehicles and, more particularly, to vehicles that include a hood striker bracket.

### BACKGROUND

This section provides background information related to the present disclosure which is not necessarily prior art.

In vehicles, especially passenger cars and light trucks, there is a desirability to have a desired give in the hood if a force is applied to the hood. If the force is applied to the hood, the hood reacts to the force by absorbing the force so that a reduced impact occurs. Various types of brackets have been proposed that provide a cushioning effect when the roof is impacted. Generally, the brackets are positioned between the inner and outer panel of the hood. Thus, if an object impacts the hood, the bracket absorbs the force to reduce the impact on the hood. While various types of brackets exist in the art, designers strive to improve the art. Designers desire to have a bracket that enables cushioning of an impact while providing desired durability performance when the hood is slammed onto the vehicle.

Accordingly, the present bracket provides such features in the art.

The present disclosure provides a striker bracket that is positioned between the inner and outer panels of the hood. The striker bracket enables increased force absorption to enable the hood to move farther towards the vehicle when the impact occurs on the hood. The present disclosure provides spring legs that provide flexibility to absorb energy. Thus, due to the flexibility of the legs, the hood provides an increase in vertical movement.

### SUMMARY

This section provides a general summary of the disclosure, and is not a comprehensive disclosure of its full scope or all of its features.

According to a first aspect of the disclosure, a hood striker bracket comprises a body with a securement member to secure the bracket with a vehicle hood. At least one leg extends from the body. The at least one leg is flexible to absorb energy exerted on the hood. A flange extends from the leg. The flange extends in a direction towards the body with a vertex formed in the at least one leg. The vertex divides the leg into two portions angled with respect to one another with the angle being less than 180 degrees. Two legs are preferred, with one on each side of the body. Reinforcement ribs are formed in the body with at least one formed at a junction of the body and the at least one leg. The at least one leg has an aperture forming two leg members with a web between the two legs with the flange extending from the web. At least one rib reinforcement is between the web and the flange. The two leg members provide a spring force for the at least one leg. The body includes an aperture to receive a vehicle hook.

According to a second aspect of the disclosure, a vehicle comprises a hood with an inner and outer panel. A striker bracket is positioned in the hood between the inner and outer panels. The striker bracket comprises a body with a securement member to secure the bracket with a vehicle hood. At least one leg extends from the body. The at least one leg is flexible to absorb energy exerted on the hood. A flange extends from the at least one leg. The flange extends in a direction towards the body with a vertex formed in the at least one leg. The vertex divides the leg into two portions angled with respect to one another with the angle being less than 180 degrees. Two legs are preferred, with one on each side of the body. Reinforcement ribs are formed in the body with at least one at a junction of the body and the at least one leg. The at least one leg has an aperture forming two leg members with a web between the two legs with the flange extending from the web. At least one rib reinforcement is formed between the web and the flange. The two leg members provide a spring force for the at least one leg. The body includes an aperture to receive a vehicle hook.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective schematic view of a striker bracket on a vehicle.

FIG. 2 is a perspective view of the striker bracket on the vehicle.

FIG. 3 is a rear perspective view of the striker bracket.

FIG. 4 is a front elevation view of the striker bracket.

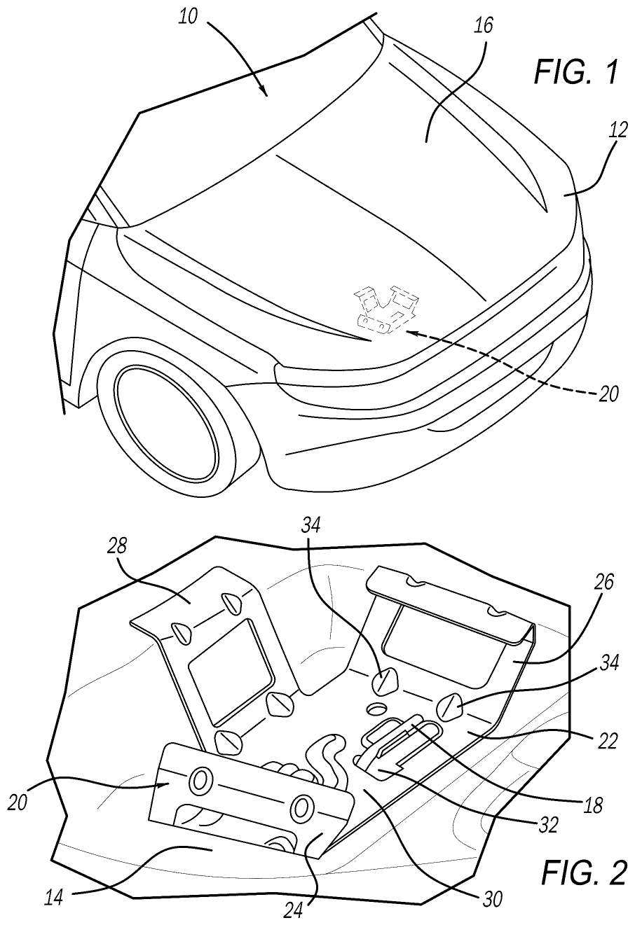

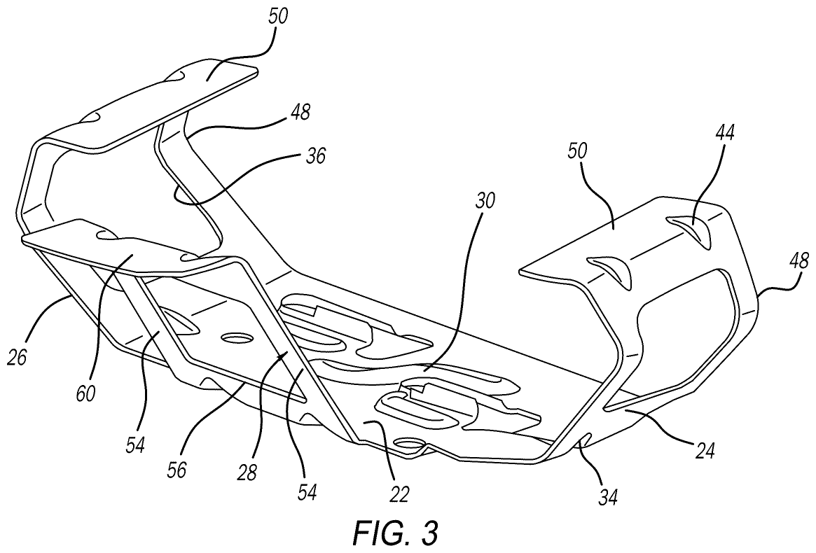

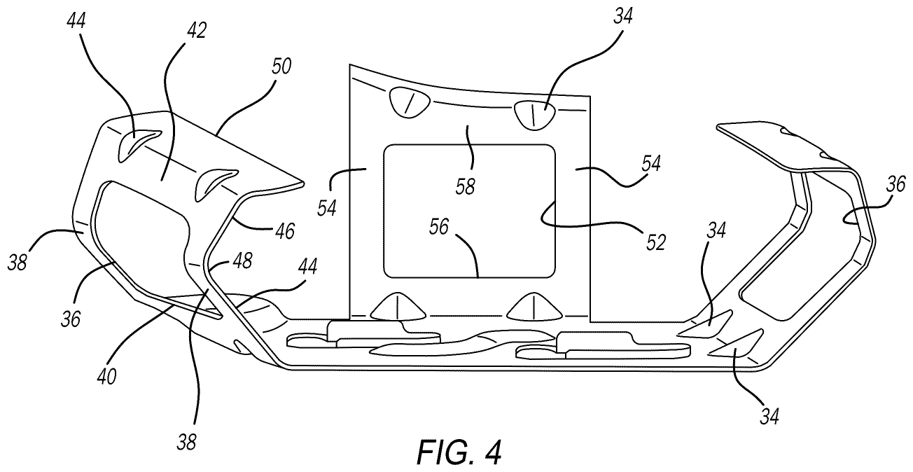

Corresponding reference numerals indicate corresponding parts throughout the several views of the drawings.

### DETAILED DESCRIPTION

Example embodiments will now be described more fully with reference to the accompanying drawings.

Turning to figures, a vehicle is illustrated and designated with the reference numeral 10. The vehicle includes a hood 12 at the front of the vehicle. The hood 12 includes an inner panel 14 and an outer panel 16. The vehicle 10 includes a hook 18 that projects through the inner panel 14 into a striker bracket 20.

The bracket 20 includes a body 22, a pair of flexible spring legs 24, 26 as well as an attachment leg 28. The body 22 has an overall rectangular configuration with the spring legs 24, 26 extending from the lateral sides of the body. The securement leg 28 extends from a longitudinal side of the body 22. The body 22 includes rib reinforcements ribs 30 on the body as well as an aperture 32 to receive the hook 18. Also, the body includes reinforcement ribs 34 at the junction of the body 22 and the legs 24, 26 and 28. The reinforcement ribs 34 provide support for the legs 24-28.

The legs 24, 26 are substantially identical and the explanation of one will apply to both. The leg 24 includes an aperture 36 dividing the leg into a pair of leg members 38 and webs 40 and 42. The aperture 36 has an overall rectangular configuration dividing the leg 24. The leg members 38 include portions 44, 46 connected by a vertex 48. Thus, the portions 44, 46 are angled with respect to one another with the vertex joining the portions 44, 46 together.

Generally, an angle between the portions 44, 46 is less than 180 degrees. Preferably, the angle between the two portions 44, 46 is between ____ degrees to ____ degrees. This provides a desired flexion for the leg 24.

The leg portions 46 are connected to the web 42. The web 42 includes a flange 50 that extends from the web 42. The web includes reinforcements 44, at the juncture, of flange 50 with the web 42. The flange 50 projects towards the other spring leg 26, such that the flange 50 is positioned over the body 22. The flange 50 provides a surface to secure the spring legs 24, 26 of the outer panel 16. Thus, when the bracket 20 is installed between the inner 14 and outer 16 panels, the two leg members 38 provide the legs 24, 26 with a spring action to absorb energy when an object impacts the outer panel 16 of the hood 12.

The securement leg 28 includes an aperture 52 dividing the leg 28 into leg portions 54 and webs 56, 58. Web 56 is connected with the body 22 and includes reinforcements ribs 34 at the junction of the web 56 and the body 22. The leg portions 54 angle away from the body 22 to provide an obtuse angle between the leg portions 54 and the body 22. The web 58 includes a flange 60 the projects away from the body 22. The flange 60 is parallel with the body 22 to enable the leg 28 to be secured with the outer panel 16 of the hood 12.

Thus, when the bracket 20 is installed between the inner 14 and outer 16 panels of the hood 12, the legs 24, 26 act as springs to provide flexibility and to absorb impact energy that is applied to the outer panel 16 of the hood 12. Thus, as an impact occurs on the outer panel 16 of the hoods 12, the legs 24, 26 deflect and move towards the body to provide an increase in the vertical movement of the outer panel 16 as it moves towards the inner panel 14. The legs 24, 26 also absorb the energy that is exerted by the impact to enable more deflection and cushioning by the bracket 20. Thus, the bracket 20 absorbs more energy as an object contacts the outer panel 16 moving it towards the inner panel 14 of the hood 12 and the vehicle 10.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hood striker bracket comprising:
a body with a securement member to secure the bracket with a vehicle hood;
at least one leg extending from the body, the at least one leg being flexible to absorb energy exerted on the hood; and
a flange extending from the leg, the flange extends in a direction towards the body with a vertex formed in the at least one leg.

2. The hood striker bracket of claim 1, wherein the vertex divides the leg into two portions angled with respect to one another with the angle being less than 180°.

3. The hood striker bracket of claim 1, further comprising two legs, one on each side of the body.

4. The hood striker bracket of claim 1, wherein reinforcement ribs are formed in the body and at least at a junction of the body and the at least one leg.

5. The hood striker bracket of claim 1, wherein the at least one leg has an aperture forming two leg members with a web between the two legs with the flange extending from the web.

6. The hood striker bracket of claim 5, wherein at least one rib reinforcement is between the web and the flange.

7. The hood striker bracket of claim 5, wherein the two leg members provide a spring force for the at least one leg.

8. The hood striker bracket of claim 1, wherein the body includes an aperture for receiving a vehicle hook.

9. A vehicle comprising:
a hood with an inner and outer panel;
a striker bracket positioned between the inner and outer panel, the striker bracket comprising:
a body with a securement member to secure the bracket with the vehicle hood;
at least one leg extending from the body, the at least one leg being flexible to absorb energy exerted on the hood; and
a flange extends from the leg, the flange extends in a direction towards the body and a vertex is formed in the at least one leg.

9. The vehicle of claim 9, wherein the vertex divides the leg into two portions angled with respect to one another with the angle being less than 180°.

10. The vehicle of claim 9, further comprising two legs, one on each side of the body.

11. The vehicle of claim 9, wherein reinforcement ribs are formed in the body and at least a junction of the body and the at least one leg.

12. The vehicle of claim 9, wherein the at least one leg has an aperture forming two leg members with a web between the two leg members with the flange extending from the web.

13. The vehicle of claim 12, wherein at least one rib reinforcement is between the web and the flange.

14. The vehicle of claim 12, wherein the two leg members provide a spring force for the at least one leg.

15. The vehicle of claim 9, wherein the body includes an aperture for receiving a vehicle hook.
